(19) United States
(12) Patent Application Publication
(10) Pub. No.: US 2012/0134657 A1
(43) Pub. Date: May 31, 2012

(54) FLOATING PERISCOPE IN PARTICULAR FOR AN UNDERWATER VEHICLE

(75) Inventors: Patrick Louvet, Toulon (FR); Julie Aujoulat, Marseille (FR)

(73) Assignee: DCNS, Paris (FR)

(21) Appl. No.: 13/264,562

(22) PCT Filed: Jan. 25, 2010
(86) PCT No.: PCT/FR10/50101

§ 371 Date: Jan. 30, 2012

(30) Foreign Application Priority Data
Apr. 17, 2009 (FR) 09 52522

(51) Int. Cl. G03B 17/08

(52) U.S. Cl. 396/25

(57) ABSTRACT

The invention relates to a floating periscope in particular for an underwater vehicle, comprising a floating container (5) having an elongate shape, one end of which is adapted to project above the water level and having means (6) for filming the environment, supported by a stabilized platform (8) which is in turn supported by gimbal suspension means (11), characterized in that the stabilized platform (8) is combined with at least one stabilizing rod (9) extending along the longitudinal axis of the container (5) and one end of which is combined with means forming a counterweight (10) for position stabilization.

The present invention relates to a floating periscope, in particular for an underwater vehicle.

### BACKGROUND

Already known in the state of the art are floating periscopes, in particular for underwater vehicles of that type, comprising a floating container having an elongate shape, one end of which is adapted to project above the water level and having means for filming the environment, supported by a stabilized platform which is in turn supported by a gimbal suspension means.

Such a system is for example known from document U.S. Pat. No. 7,279,675.

Such systems have been developed to improve the discretion of underwater vehicles, and in particular submarines strictly speaking.

In fact, such floating periscopes can be used to replace or complement periscopes integral therewith, which require being lifted above the surface of the water and from the submarine, whereas the latter uses periscopic submersion at a reduced speed.

One can thus see that this situation translates to the fact that the submarine is relatively vulnerable. In fact, it is in fairly shallow submersion and even if the submarine moves slowly, the periscope leaves a visible trail on the surface of the water.

Relative to these periscopes hoisted from the body of the submarine, floating periscopes having a certain number of advantages, inasmuch as the submersion of the submarine is of little importance and a floating periscope does not leave a visible trail.

However, in these floating periscopes as illustrated by the prior document, the problem arises of the stability of the filming means.

In fact, the periscope is subject to different movements, and in particular the movements of the waves, etc., so that it is necessary to use means for stabilizing the filming means.

These stabilization means can for example be gyroscopic stabilization means associated with the support platform of the filming means, or computer stabilization means using processing of the images delivered by these filming means.

### SUMMARY OF THE INVENTION

One can see, however, that these different means are relatively complex and expensive to implement.

The aim of the invention is therefore to resolve these problems.

It is an object of the present invention to provide a floating periscope, in particular for underwater vehicles, comprising a floating container having an elongate shape, one end of which is adapted to project above the water level and having means for filming the environment, supported by a stabilized platform which is in turn supported by a gimbal suspension means, characterized in that the stabilized platform is combined with at least one stabilizing rod extending along the longitudinal axis of the container whereof one end is associated with the platform and the other end of which is combined with means forming a counterweight for position stabilization.

According to other aspects of the invention, the floating periscope comprises one or more of the following features:

the end of the container adapted to project above the water level and including means for filming the environment, includes a transparent porthole,

the stabilization platform is mounted hinged in a frame around a first axis, and said frame is articulated on the rest of the container around a second axis perpendicular to the first,

the container is cylindrical,

the filming means comprise means forming cameras,

it includes means for transmitting information intended for the underwater vehicle,

the information transmission means are wired means,

it includes means for accelerating its rising speed toward the surface after casting off, in order to cause it to jump above the surface of the water and waves,

the underwater vehicle is a submarine strictly speaking,

the underwater vehicle is an underwater drone, and

the underwater vehicle is underwater equipment made available to a diver.

### BRIEF DESCRIPTION OF THE DRAWINGS

The invention will be better understood using the following description provided solely as an example and done in reference to the appended drawings, in which:

FIG. 1 illustrates the usage principle of a floating periscope according to the invention,

FIG. 2 shows a side view of such a periscope,

FIG. 3 shows a perspective view of the internal structure of such a periscope,

FIG. 4 shows a top view of said structure, and

FIG. 5 shows a cross-sectional view of such a structure.

### DETAILED DESCRIPTION

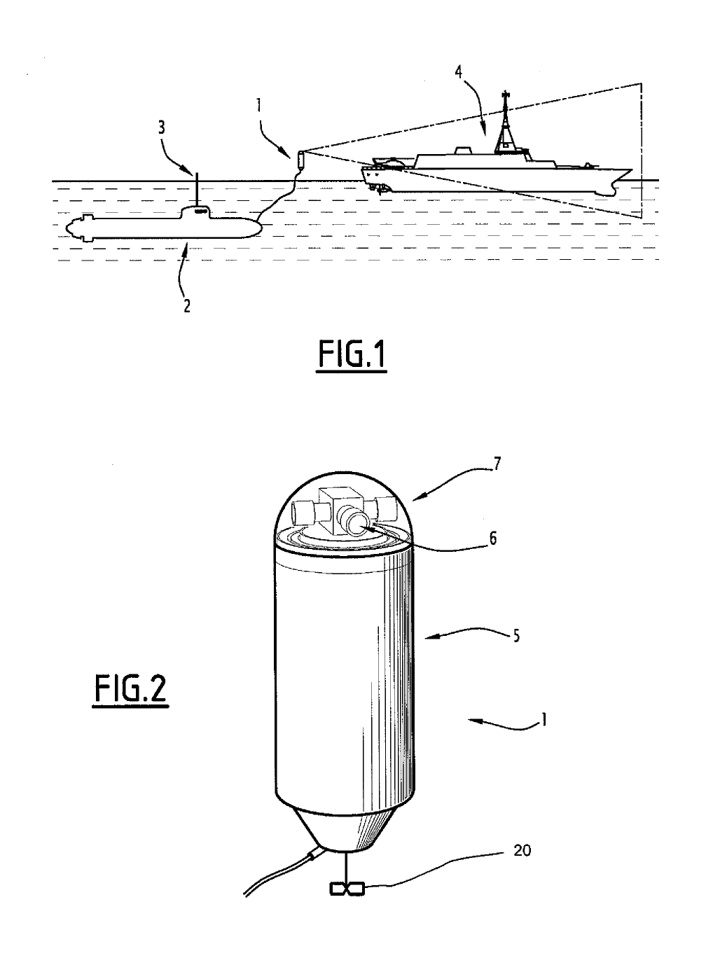

As previously indicated, a floating periscope like that designated by general reference 1 in these figures can be deployed for example from an underwater vehicle designated by general reference 2 in FIG. 1, said underwater vehicle for example being a submarine strictly speaking.

Such a floating periscope can for example be used to complete or replace the use of a periscope integral with the submarine like the periscope designated by general reference 3 in FIG. 1, and then makes it possible to observe the environment thereof, and for example to detect surface vessels, like the building designated by general reference 4 in that FIG. 1.

As illustrated in FIG. 2, the periscope according to the invention includes a floating container designated by general reference 5 in that figure, said floating container having an elongate shape, one end of which is adapted to project above the surface of the water and includes means 6 for filming the environment, supported by a stabilized platform which is in turn supported by gimbal suspension means.

In the illustrated example, the filming means 6 are for example formed by the means forming cameras and are positioned under a transparent dome 7 of the corresponding end of the container 5.

This container can for example be connected by information transmitting means such as, for example, wired means, intended for the underwater vehicle.

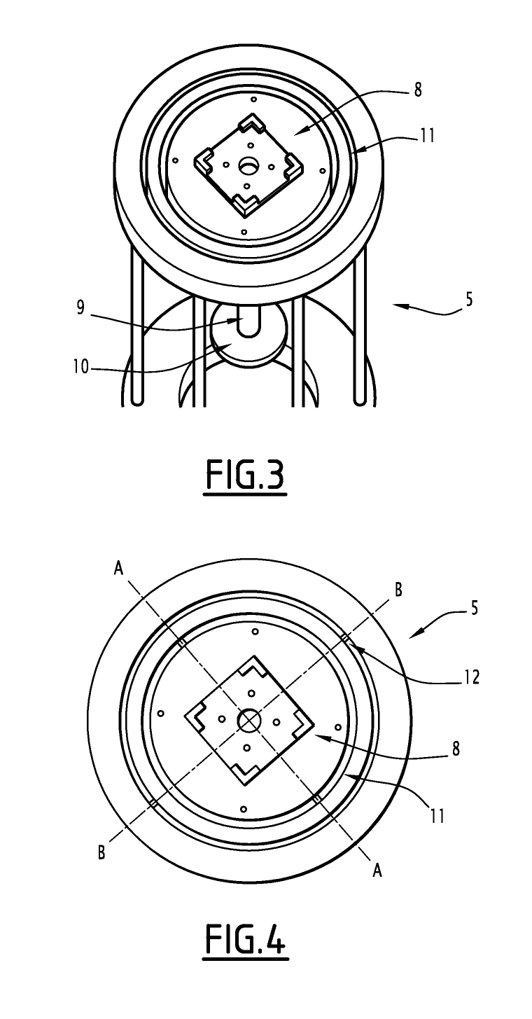

In fact and as illustrated in FIGS. 3, 4 and 5, the means 6 for filming the environment are supported by a stabilized platform designated by general reference 8 in these figures, associated with at least one stabilizing rod designated by general reference 9, extending along the longitudinal axis of the container 5, the latter for example being cylindrical, and one end of which is associated with the platform and the other end of which is associated with means forming a counterweight for position stabilization, designated by general reference 10.

In fact and as illustrated, the stabilization platform 8 is mounted articulated in a frame 11 along a first axis A-A, said frame 11 in turn being articulated on the rest of the container around a second axis B-B perpendicular to the first.

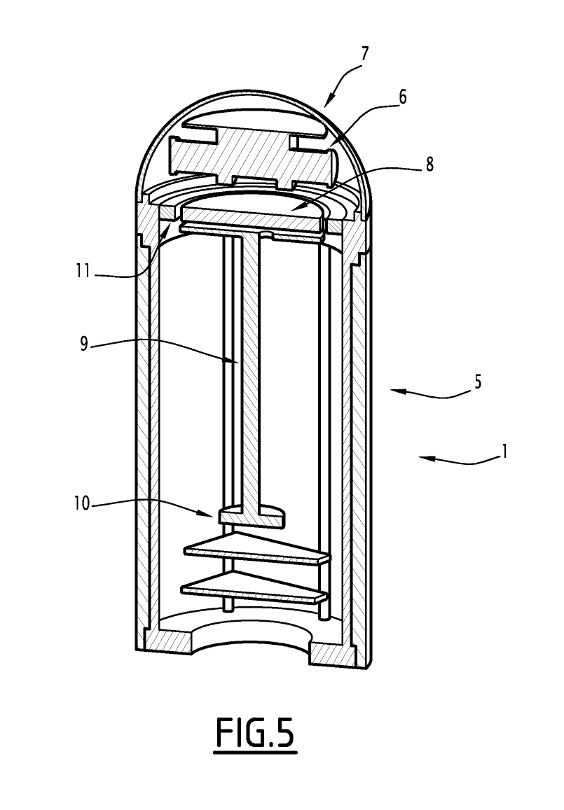

As illustrated in these figures, the platform and the frame are articulated to one another, and relative to the rest of the periscope structure via articulating rod portions, one of which is for example designated by general reference 12 in FIG. 4.

Of course such a floating periscope can be used from an underwater vehicle that can assume the form of a submarine strictly speaking, an underwater drone or underwater equipment for example made available to divers, which can thus remain discrete in the context mentioned in the preamble of the present description.

Furthermore, the container can also be equipped with means for accelerating its rising speed toward the surface after casting off, in order to cause it to jump above the surface of the water and in particular above the waves, and to thereby make it possible to improve observation of the environment.

In fact, mechanical, pyrotechnic, hydraulic or pneumatic means, shown schematically as 20 in FIG. 2, can be associated with the container to accelerate its rising speed.

It may in fact be particularly advantageous to obtain film of the environment of said periscope when it is at the apex of its aerial phase above the surface of the water, in order to increase the observation range.

The processing of the delivered images can then be done in real time or deferred.

Of course, the filming means can be formed by means of different types, cameras, photographic cameras, IR, etc.

For example, tests have shown that the use of four cameras positioned at 90° from one another would make it possible to obtain very good monitoring of the environment.

Likewise, upon casting off of the floating periscope, the latter is able to deliver information concerning the environment during its movement under, at and above the surface of the water.

Furthermore, such a periscope is extremely discrete, which makes it possible to limit the risks of detection of the underwater vehicle.

The use of gimbal suspension means associated with the rod and the counterweight makes it possible to greatly limit the instability phenomenon of the obtained images, and the obtained result can be improved owing to digital image processing, as is known.

Of course, other embodiments can also be considered.

What is claimed is:

1-11. (canceled)

12. A floating periscope comprising:
a floating container having an elongate shape with a longitudinal axis and a first end adapted to project above a water level;
a filming device for filming the environment;
a stabilized platform supporting the filming device;
a gimbal suspension supporting the stabilized platform;
at least one stabilizing rod extending along the longitudinal axis of the container and having a first rod end and a second rod end, the stabilized platform being connected to the at least one stabilizing rod, the first rod end associated with the platform; and
a counterweight for position stabilization connected to the second rod end.

13. The floating periscope as recited in claim 12 wherein the first end includes a transparent porthole for the filming device.

14. The floating periscope as recited in claim 12 wherein the gimbal suspension includes a frame, the stabilization platform mounted hinged in the frame around a first axis, and the frame being articulated on the rest of the container around a second axis perpendicular to the first.

15. The floating periscope as recited in claim 12 wherein the container is cylindrical.

16. The floating periscope as recited in claim 12 wherein the filming device includes cameras.

17. The floating periscope as recited in claim 12 further comprising a transmitter for transmitting information intended for an underwater vehicle.

18. The floating periscope as recited in claim 17 transmitter includes a wire.

19. The floating periscope as recited in claim 12 further comprising an accelerator accelerating a rising speed toward the surface after casting off, in order to cause the periscope to jump above the surface of the water and waves.

20. The floating periscope as recited in claim 12 wherein the periscope is associated with an underwater vehicle.

21. The floating periscope as recited in claim 20 wherein the underwater vehicle is a submarine.

22. The floating periscope as recited in claim 20 wherein the underwater vehicle is an underwater drone.

23. The floating periscope as recited in claim 20 wherein the underwater vehicle is underwater equipment made available to a diver.
